(19) United States
(12) Patent Application Publication
(10) Pub. No.: US 2010/0294213 A1
(43) Pub. Date: Nov. 25, 2010

(54) COLLAR OR HALTER FOR PETS, EQUIPPED WITH ADJUSTABLE FASTENING AND FIXING MEANS

(75) Inventor: Carlo Vaccari, Castelgomberto (IT)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(73) Assignee: FERPLAST SPA, Castelgomberto, IT (unknown)

(21) Appl. No.: 12/668,863

(22) PCT Filed: Jun. 18, 2008
(86) PCT No.: PCT/IT08/00403

§ 371 Date: May 12, 2010

(30) Foreign Application Priority Data
Jun. 21, 2007 (IT) VR2007A000088

(51) Int. Cl. A01K 27/00

(52) U.S. Cl. 119/863

(57) ABSTRACT

An adjustable collar or harness (10) for pets that comprises a strap (11) provided with flaps fitted with reciprocal coupling means, and a ring (12) or similar designed to be attached to a spring clip of a lead, wherein the means for coupling the ends of the strap (11) consist of at least one toothed tab or tape (13) designed to couple with at least one spring pushbutton (or a lever) (17) which grips one or more teeth of the toothed tape (13) allowing the automatic blocking and release of the toothed tape, when appropriately operated.

### SUBJECT OF THE INVENTION

This invention refers to a collar or halter/harness for pets, mainly for dogs but also for other animals, which is constructed with technology that makes it possible to fit it very quickly and simply and at the same time allowing particular adjustment elements to be operated in order to alter the size as required.

More specifically, this invention refers to a collar or harness which differs from common collars or harnesses in that it is made using a completely innovative blocking system since the closing method can be adjusted as required, avoiding the need to remove the collar from the animal in order to adjust it.

The collar according to the invention focuses on the method of closing and blocking/opening and blocking, as well as on the adjustment of the collar around the animal's neck and on the mechanisms used for this purpose.

This invention can be applied in the sector of accessories for pets, in particular in the sector of accessories such as collars, harnesses and leads for pets such as, for example, dogs, cats or the like.

### BACKGROUND ART

It is known that pets that need to be walked are usually accompanied using leads provided with a grip to be held by the person walking the pet, and a coupling element which is generally the spring clip type for attaching the lead to a collar or harness.

It is also known that traditional collars comprise a strap with ends that can be joined by any suitable means to form a circle designed to be wrapped around the neck or a part of the body of a pet.

The collar also comprises a ring so that it can be attached to a spring clip that can be fixed to the cord of a lead so that the person walking the pet can always keep the animal under complete and secure control when walking.

The coupling means for the ends of the collar can consist of a buckle, a clip type fastening or even a bayonet type fastening, in any case such as to ensure safety against any abrupt movements of the pet, above all if the animal is large. The same applies to harnesses.

One drawback encountered with traditional collars is represented by the fact that there are no models that cover all sizes of animals from when the animal is young to when it is an adult, without being completely or at least partially replaced.

Another drawback concerns the fact that all the collars on the market have to be taken off the animal before they can be adjusted.

Most products also require the use of both hands in order to remove them from the animal.

Yet another problem with traditional collars concerns the fact since they have to adapt well to the animal without being too tight or too loose, they must be made in different sizes according to the size of the animal itself.

An additional problem is that the purchaser often buys the collar without first testing it on the animal and at times finds that it does not match with the size of the animal.

Yet again, from an industrial point of view, the fact of being obliged to have various sizes of collars is not economically advantageous, as this requires different production lines and more storage space for stocks, having to produce numerous series of collars in different lengths according to the size of the animal on which the collar will be fitted.

### DESCRIPTION OF THE INVENTION

This invention proposes to provide an adjustable collar or harness for pets that can eliminate or significantly reduce the drawbacks described above.

This invention also proposes to provide a collar or harness that can be easily fitted on pets of any size and adjusted without having to remove it from the animal's neck.

An additional aim of this invention is to provide an adjustable collar or harness for pets that is easy to produce and thus with a limited production cost in order to be advantageous from a financial point of view.

This is achieved by means of an adjustable collar or harness with the features described in the main claim.

The dependent claims describe advantageous embodiments of the invention.

The adjustable collar or harness for pets according to the invention therefore substantially consists of an upper strap fitted with a half-ring for attachment to a lead and with one of the two pairs of mechanisms such as spring pushbuttons or levers, and of a neck-band which can be padded, if required, fitted with the second pair of toothed tape type mechanisms.

In a similar way to the collar, in the case of a harness the mechanisms double in number.

### DESCRIPTION OF THE DRAWINGS

Other features and advantages of the invention will become evident on reading the following description of one embodiment of the invention, given as a non-binding example, together with the accompanying drawings in which:

FIG. 1 represents a schematic view of a collar according to the invention seen from the front;

FIG. 2 is a schematic view of the collar according to the invention seen from the side;

FIG. 3 shows the collar in axonometric prospective;

FIG. 4 is a schematic view of the collar according to the invention seen from above;

FIGS. 5 and 6 show schematic views of the toothed tab type coupling system closed by a spring hook or lever;

FIGS. 7 to 10 show schematic views of a harness according to the invention, seen respectively from the front, the side, above and in axonometric prospective.

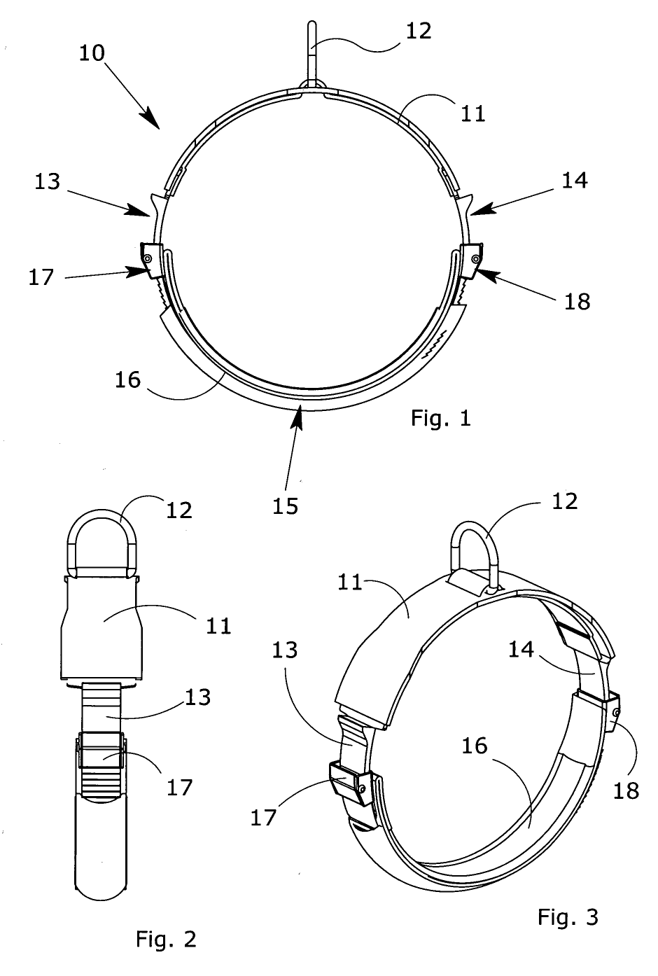

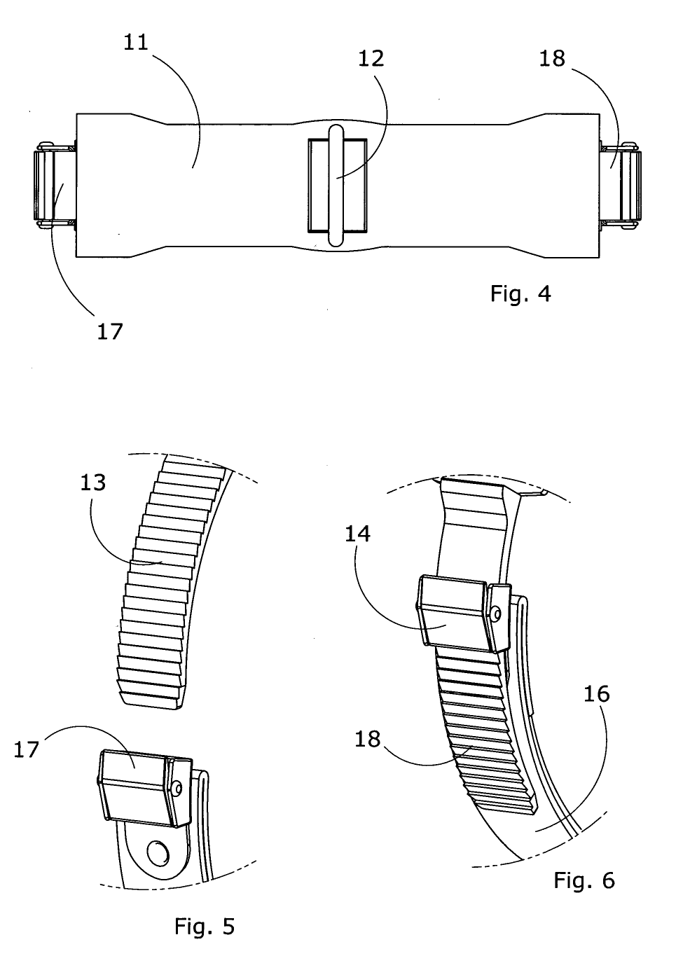

### DESCRIPTION OF ONE EMBODIMENT OF THE INVENTION

With reference to the accompanying drawings, the reference number 10 indicates a collar in general, in the case in question an adjustable collar comprising single or double components according to more or less adjustment possibilities.

Although the collar can be made with single components, we will describe one with double components, for the sake of completeness, and in this case it consists of an upper strap 11 fitted with a half-ring 12 for attachment to a lead and with one of the two pairs of mechanisms 13 and 14, and a neck-band 15, with optional padding 16, fitted with the second pair of mechanisms 17 and 18.

The first of the two pairs of mechanisms, those indicated with 13 and 14, consists of toothed tapes or tabs, while the second pair of mechanisms 17 and 18 consists of spring pushbuttons or levers.

The upper strap 11 is attached to the lower padded strap 15 simply by inserting the toothed tabs 13 and 14 in the spring pushbuttons or levers 17 and 18.

The two coupling sectors are more or less symmetrical with respect to the center line of the collar, even though this condition is not strictly necessary since the mechanical function is not altered if the parts are arranged asymmetrically.

In addition, the toothed tabs or tapes can be fitted either on the first semicircular strap 11 or on the second strap 15, and vice versa for the pushbuttons: functioning is in any case guaranteed.

To fasten the collar around the animal's neck, it is sufficient to insert the toothed tab 13 and 14 in the spring pushbuttons or levers 17 and 18 as far as the required position: the mechanism is automatically blocked and the collar cannot be loosened without pressing the relative pushbutton.

As regards the release method, it is sufficient to insert the index finger between the collar and the animal's neck and use the thumb to press the respective pushbutton or lever 17 and 18, or to apply pressure with two fingers, one against the other, to release the tab and pull in the release direction.

According to another embodiment, the collar can also be provided with pockets to contain the tabs or tapes.

These pockets have an esthetic function and also protect the tape and the animal, as they prevent the collar or one of its protruding parts from accidentally catching on obstacles such as branches, fences or the like.

According to yet another embodiment, the collar can also be provided with elements that protect or block the pushbutton/s (or lever) that prevent any accidental opening.

As can be noted, and as already mentioned, this collar can be adjusted while it is being worn by the animal, and the mechanism allows the collar to be removed using just one hand: it is sufficient to press the release button and pull to achieve complete opening.

The collar according to the invention also allows replacement of just the front strap, containing the padding, so as to cover various sizes, from “small” to “extralarge”, without having to replace the item completely when the animal grows a size larger.

Finally, it should be noted that the presence of two pairs of mechanisms also allows double adjustment of the neck-band thus ensuring centering of the padding on the front part of the animal's neck: this is in fact the area must subject to traction during use of the collar attached to a lead.

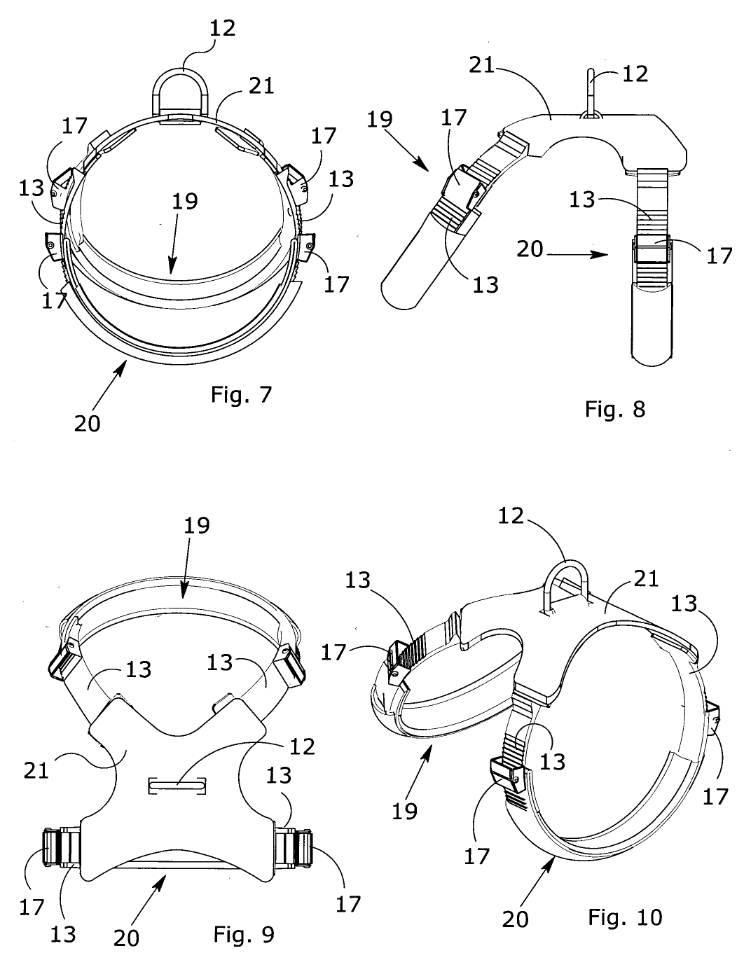

FIGS. 7 to 10 show a similar harness-type solution, and in this case the coupling points are doubled since the harness can be fastened either in the collar or neck-band area, or in the chest or under-belly area.

According to this solution, the two straps 19 and 20 are fixed to the upper strap 21 (on which the half-ring 12 is fitted) at the four coupling points and each of these is fitted with at least a first toothed tab mechanism 13 and at least a second spring pushbutton or lever mechanism 17.

There can thus be either one or more coupling points for each neck or under-belly strap.

The invention is described above with reference to a preferred embodiment. It is nevertheless clear that the invention is susceptible to numerous variations that lie within the framework of technical equivalents.

1-12. (canceled)

13. An adjustable collar or harness for pets comprising a strap provided with flaps fitted with reciprocal couplings, and a ring for attachment to a spring clip of a lead, the ends of the strap including at least one toothed tape coupling with at least one spring pushbutton or lever, the pushbutton or lever being for gripping at least one tooth of the toothed tape thereby allowing the automatic selective blocking or release of the toothed tape.

14. An adjustable collar or harness according to claim 13, wherein the toothed tape is dimensioned to resist pulling loads, and allows for fine adjustment of the length of a neck-band.

15. An adjustable collar or harness according to claim 13, including a double structure wherein the tape and the spring pushbuttons or levers are double pairs and the range of adjustment is double.

16. An adjustable collar or harness according to claim 13, wherein the strap includes an upper strap fitted with a half-ring for attachment to a lead and with one of two pairs of mechanisms, and a neck-band formed by a strap, selectively with optional padding, and fitted with the second pair of mechanisms.

17. An adjustable collar or harness according to claim 13, including a first of two pairs of mechanisms includes toothed tapes, and the second pair of mechanisms includes spring pushbuttons or levers.

18. An adjustable collar or harness according to claim 13, wherein the strap includes an upper strap attached to a lower strap, and including padding inserted with the toothed tabs in the spring pushbuttons or levers.

19. An adjustable collar or harness according to claim 13, including two coupling sectors relatively symmetrical with respect to the center-line of the collar.

20. An adjustable collar or harness according to claim 13, wherein the toothed tapes are fitted selectively either on a first semicircular strap or on a second strap, and vice versa for the pushbuttons.

21. An adjustable collar or harness according to claim 13, wherein the collar includes pockets for containing the tapes.

22. An adjustable collar or harness according to claim 13, including a pocket for protecting the tapes and the animal.

23. An adjustable collar or harness according to claim 13, wherein the collar includes elements for protecting or blocking the pushbutton or lever thereby to minimize or prevent accidental opening.

24. An adjustable collar or harness according to claim 13, including a structure for permitting replacement of the front part, selectively containing padding, thereby to cover various sizes from smaller to larger without having to replace the collar or harness.

25. An adjustable collar or harness for pets comprising a strap provided with flaps fitted with reciprocal couplings, and a ring for attachment to a spring clip of a lead, the ends of the strap including at least one toothed tab to coupling with at least one spring pushbutton or lever, the pushbutton or lever being for gripping at least one tooth of the toothed tab, thereby allowing the automatic selective blocking or release of the toothed tab.

26. An adjustable collar or harness according to claim 25, wherein the toothed tab is dimensioned to resist pulling loads, and allows for fine adjustment of the length of a neck-band.

27. An adjustable collar or harness according to claim 25, including a double structure wherein the spring pushbuttons or levers are double pairs and the range of adjustment is double.

28. An adjustable collar or harness according to claim 25, wherein the strap includes an upper strap is fitted with a half-ring for attachment to a lead and with one of two pairs of mechanisms, and a neck-band formed by a strap, selectively with optional padding, and fitted with the second pair of mechanisms.

29. An adjustable collar or harness according to claim 25, including a first of two pairs of mechanisms includes toothed tabs, and the second pair of mechanisms includes spring pushbuttons or levers.

30. An adjustable collar or harness according to claim 25, wherein the strap includes an upper strap attached to a lower strap, and including padding inserted with the toothed tabs in the spring pushbuttons or levers.

31. An adjustable collar or harness according to claim 25, including two coupling sectors relatively symmetrical with respect to the center-line of the collar.

32. An adjustable collar or harness according to claim 25, wherein the toothed tabs are fitted selectively either on a first semicircular strap or on a second strap, and vice versa for the pushbuttons, and wherein the collar includes pockets for containing the tabs, a pocket for protecting the animal, and the collar including elements for protecting or blocking the pushbutton or lever thereby to minimize or prevent accidental opening.
